(19) United States
(12) Patent Application Publication
(10) Pub. No.: US 2023/0080424 A1
(43) Pub. Date: Mar. 16, 2023

(54) DYNAMIC CAUSAL DISCOVERY IN IMITATION LEARNING

(71) Applicant: NEC Laboratories America, Inc., Princeton, NJ (US)

(72) Inventors: Wenchao Yu, Plainsboro, NJ (US); Wei Cheng, Princeton Junction, NJ (US); Haifeng Chen, West Windsor, NJ (US); Yuncong Chen, Plainsboro, NJ (US); Xuchao Zhang, Elkridge, MD (US); Tianxiang Zhao, State College, PA (US)

(21) Appl. No.: 17/877,081

(22) Filed: Jul. 29, 2022

Related U.S. Application Data
(60) Provisional application No. 63/237,637, filed on Aug. 27, 2021.
(60) Provisional application No. 63/308,622, filed on Feb. 10, 2022.

(51) Int. Cl. G06N 7/00

(52) U.S. Cl. CPC G06N 7/005; G06N 20/00

(57) ABSTRACT

A method for learning a self-explainable imitator by discovering causal relationships between states and actions is presented. The method includes obtaining, via an acquisition component, demonstrations of a target task from experts for training a model to generate a learned policy, training the model, via a learning component, the learning component computing actions to be taken with respect to states, generating, via a dynamic causal discovery component, dynamic causal graphs for each environment state, encoding, via a causal encoding component, discovered causal relationships by updating state variable embeddings, and outputting, via an output component, the learned policy including trajectories similar to the demonstrations from the experts.

This application claims priority to Provisional Application No. 63/237,637 filed on Aug. 27, 2021, and Provisional Application No. 63/308,622 filed on Feb. 10, 2022, the contents of both of which are incorporated herein by reference in their entirety.

### BACKGROUND

### Technical Field

The present invention relates to imitation learning and, more particularly, to dynamic causal discovery in imitation learning.

### Description of the Related Art

Imitation learning, which learns agent policy by mimicking expert demonstration, has shown promising results in many applications such as medical treatment regimens and self-driving vehicles. However, it remains a difficult task to interpret control policies learned by the agent. Difficulties mainly come from two aspects, that is, agents in imitation learning are usually implemented as deep neural networks, which are black-box models and lack interpretability, and the latent causal mechanism behind agents' decisions may vary along the trajectory, rather than staying static throughout time steps.

### SUMMARY

A method for learning a self-explainable imitator by discovering causal relationships between states and actions is presented. The method includes obtaining, via an acquisition component, demonstrations of a target task from experts for training a model to generate a learned policy, training the model, via a learning component, the learning component computing actions to be taken with respect to states, generating, via a dynamic causal discovery component, dynamic causal graphs for each environment state, encoding, via a causal encoding component, discovered causal relationships by updating state variable embeddings, and outputting, via an output component, the learned policy including trajectories similar to the demonstrations from the experts.

A non-transitory computer-readable storage medium comprising a computer-readable program for learning a self-explainable imitator by discovering causal relationships between states and actions is presented. The computer-readable program when executed on a computer causes the computer to perform the steps of obtaining, via an acquisition component, demonstrations of a target task from experts for training a model to generate a learned policy, training the model, via a learning component, the learning component computing actions to be taken with respect to states, generating, via a dynamic causal discovery component, dynamic causal graphs for each environment state, encoding, via a causal encoding component, discovered causal relationships by updating state variable embeddings, and outputting, via an output component, the learned policy including trajectories similar to the demonstrations from the experts.

A system for learning a self-explainable imitator by discovering causal relationships between states and actions is presented. The system includes a memory and one or more processors in communication with the memory configured to obtain, via an acquisition component, demonstrations of a target task from experts for training a model to generate a learned policy, train the model, via a learning component, the learning component computing actions to be taken with respect to states, generate, via a dynamic causal discovery component, dynamic causal graphs for each environment state, encode, via a causal encoding component, discovered causal relationships by updating state variable embeddings, and output, via an output component, the learned policy including trajectories similar to the demonstrations from the experts.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram of an exemplary practical scenario of causal discovery for an imitation learning model, in accordance with embodiments of the present invention;

FIG. 2 is a block/flow diagram of an exemplary system implementing causal discovery for imitation learning, in accordance with embodiments of the present invention;

FIG. 3 is a block/flow diagram of an exemplary framework of the self-explainable imitation learning framework referred to as Causal-Augmented Imitation Learning (GAIL), in accordance with embodiments of the present invention;

FIG. 4 is a block/flow diagram illustrating an overview of the dynamic causal discovery component of CAIL, in accordance with embodiments of the present invention;

FIG. 5 is a block/flow diagram of an exemplary graph illustrating the dynamic causal discovery for imitation learning, in accordance with embodiments of the present invention;

FIG. 6 is an exemplary practical application for learning a self-explainable imitator by discovering causal relationships between states and actions, in accordance with embodiments of the present invention;

FIG. 7 is an exemplary processing system for learning a self-explainable imitator by discovering causal relationships between states and actions, in accordance with embodiments of the present invention; and

FIG. 8 is a block/flow diagram of an exemplary method for learning a self-explainable imitator by discovering causal relationships between states and actions, in accordance with embodiments of the present invention.

### DETAILED DESCRIPTION OF PREFERRED EMBODIMENTS

In imitation learning, neural agents are trained to acquire control policies by mimicking expert demonstrations. Imitation learning circumvents two deficiencies of traditional Deep Reinforcement Learning (DRL) methods, that is, low sampling efficiency and reward sparsity. Following demonstrations that return near-optimal rewards, an imitator can prevent a vast number of unreasonable attempts during explorations and has been shown to be promising in many real-world applications. However, despite the high performance of imitating neural agents, one problem persists on the interpretability of control policies learned by them. With deep neural networks used as the policy model, the decision mechanism of the trained neural agent is not transparent and remains a black box, making it difficult to trust the model and apply it on high-stake scenarios such as the medical domain.

Many efforts have been made to increase interpretability of policy agents. For example, some efforts compute saliency maps to highlight critical features using gradient information or attention mechanism, other efforts include model interactions among entities via relational reasoning, and yet other efforts design sub-tasks to make decisions with symbolic planning. However, these methods either provide explanations that are noisy and difficult to interpret, only in the instance level without a global view of the overall policy or make too strong of assumptions on the neural agent and lack generality.

To increase interpretability of the learned neural agent, the exemplary methods propose to explain it from the cause-effect perspective, exposing causal relations among observed state variables and outcome decisions. Inspired by advances in discovering Directed Acyclic Graphs (DAGs), the exemplary methods aim to learn a self-explainable imitator by discovering the casual relationship between states and actions. In other words, taking observable state variables and candidate actions as nodes, the neural agent can generate a DAG to depict the underlying dependency between states and actions, with edges representing causal relationships. For example, in the medical domain, the obtained DAG can include relations like “Inactive muscle responses often indicates losing of speaking capability” or “Severe liver disease would encourage the agent to recommend using Vancomycin.” Such exposed relations can improve user understanding on policies of the neural agent from a global view and can provide better explanations on decisions made by it.

However, designing such interpretable imitators from a causal perspective is a challenging task, mainly because it is non-trivial to identify causal relations behind decision-making of imitating agents. Modern imitators are usually implemented as a deep neural network, in which the utilization of features is entangled and nonlinear and lack interpretability, and because imitators need to make decisions in a sequential manner, and latent causal structures behind it could evolve over time, instead of staying static throughout the produced trajectory. For example, in a medical scenario, a trained imitator needs to make sequential decisions that specify how the treatments should be adjusted through time according to the dynamic states of the patient. There are multiple stages in the states of patients with respect to disease severity, which would influence efficacy of drug therapies and result in different treatment policies at each stage. However, directly incorporating this temporal dynamic element into causal discovery would give too much flexibility in the search space and can lead to over-fitting.

Targeting the aforementioned challenges, the exemplary methods build the causal discovery objective upon the notion of Granger causality, which declares a causal relationship sᵢ→aⱼ between variables sᵢ and aⱼ if aⱼ can be better predicted with s available than not available. A causal discovery module or component is designed to uncover causal relations among variables, and extracted causes are encoded into the embedding of outcome variables before action prediction, following the notion of Granger causality. The exemplary framework is optimized so that state variables predictive toward actions are identified, thus providing explanations on decision policy of the neural agent.

The exemplary embodiments introduce an imitator, which can produce DAGs providing interpretations on the control policy alongside predicting actions, and which is referred to as Causal-Augmented Imitation Learning (GAIL). Identified causal relations are encoded into variable representations as evidence for making decisions. With this manipulation of inputs, the onerous analysis on internal structures of neural agents is circumvented and causal discovery is modeled as an optimization task. Following the observation that the evolvement of causal structures usually follows a stage-wise process, it is assumed that a set of latent templates during the designing of the causal discovery module/component can both model the temporal dynamics across stages and allow for knowledge sharing within the same stage. Consistency between extracted DAGs and captured policies is guaranteed in design, and the exemplary framework can be updated in an end-to-end manner. Intuitive constraints are also enforced to regularize the structure of discovered causal graphs, like encouraging sparsity and preventing loops.

The main contributions are at least studying a novel problem of learning dynamic causal graphs to uncover knowledge captured, as well as latent causes behind agent's decisions, introducing a novel framework called GAIL, which is able to learn dynamic DAGs to capture the casual relation between state variables and actions, and adopt the DAGs for decision making in imitation learning.

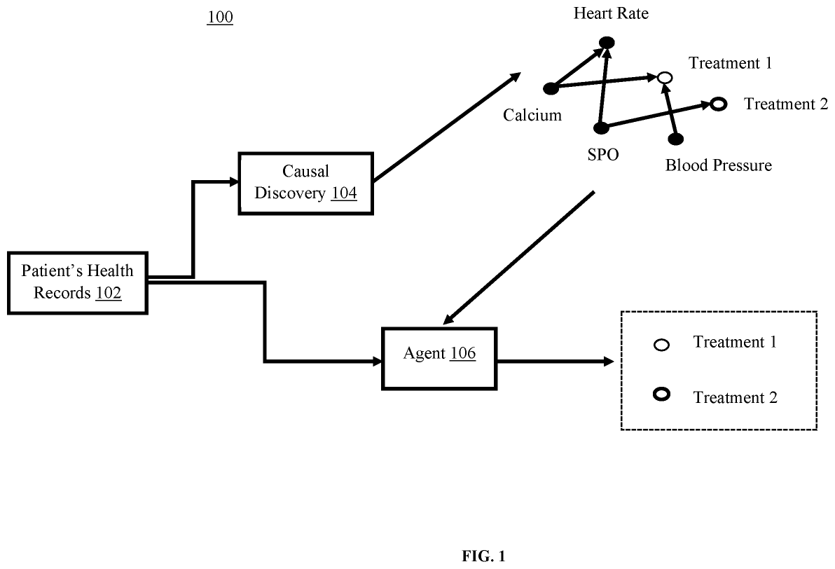

FIG. 1 is a block/flow diagram of an exemplary practical scenario of causal discovery for an imitation learning model, in accordance with embodiments of the present invention.

Causal discovery for imitation learning is a task for uncovering the causal relationships among state and action variables behind the decision mechanism of an agent model. The agent model is trained through imitation learning, in which it learns a decision policy by mimicking demonstrations of external experts. The agent model interacts with the environment by taking actions following its learnt policy, and as a result, the environment state will transit based on the actions taken. Causal structure discovery, on the other hand, focuses on discovering causal relationships within a set of variables, exposing the inter-dependency among them. The exemplary embodiments propose to improve the interpretability of the imitation learning agent, providing explanations for its action decisions, by studying it from the causal discovery viewpoint. The exemplary methods introduce an ad-hoc approach to put the imitation learning agent inside a causal discovery framework, which can uncover the causes of agent's actions, as well as the inter-dependency of those evolving state variables. Furthermore, the discovered causal relations are made dynamic, as the latent decision mechanism of the agent model could vary along with changes in the environment. With this exemplary method, a causal graph can be obtained depicting the causal dependency among state variables and agent actions at each stage, which drastically improves the interpretability of imitation learning agents.

There are many domains or practical scenarios which the present invention is applicable to. The healthcare domain is one example. In general, in the healthcare domain, the sequential medical treatment history of a patient is one expert demonstration. State variables include health records and symptoms, and actions are the usage of treatments. Relationships between symptoms and treatments could vary when patients are in different health conditions. Given a patient and the health states, the exemplary method needs to identify the current causal dependency between symptoms and actions taken by the imitation learning agent.

A practical application in the healthcare domain is shown in FIG. 1. To simplify, the model 100 has two treatment candidates (e.g., Treatment 1 and Treatment 2). However, the application is not limited to this scenario. Given the health states 102 of a patient, the agent 106 works to mimic the doctors and provide the treatments, and the exemplary method (causal discovery 104) enables it to expose the causal graph behind this decision process simultaneously. As such, the present invention improves interpretability of modern imitation learning models, thus allowing users to understand and examine the knowledge captured by agent models.

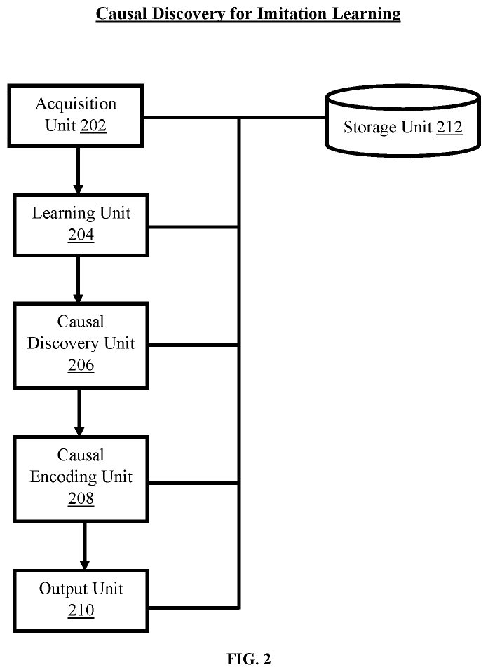

FIG. 2 is a block/flow diagram of exemplary system implementing causal discovery for imitation learning, in accordance with embodiments of the present invention.

The acquisition unit/component 202 obtains the demonstrations from the experts for training the model and outputs the learned policy. Storage units/components 212 store the models, the learned policy, the discovered causal graphs, and the output demonstration. The learning unit/component 204 is used for training the model. The causal discovery unit/component 206 is used for generating dynamic causal graphs for each environment state. The causal encoding unit/component 208 encodes discovered causal relationships as evidence that the policy model depends upon. The output unit/component 210 controls the output of the trajectory similar to the experts' demonstrations.

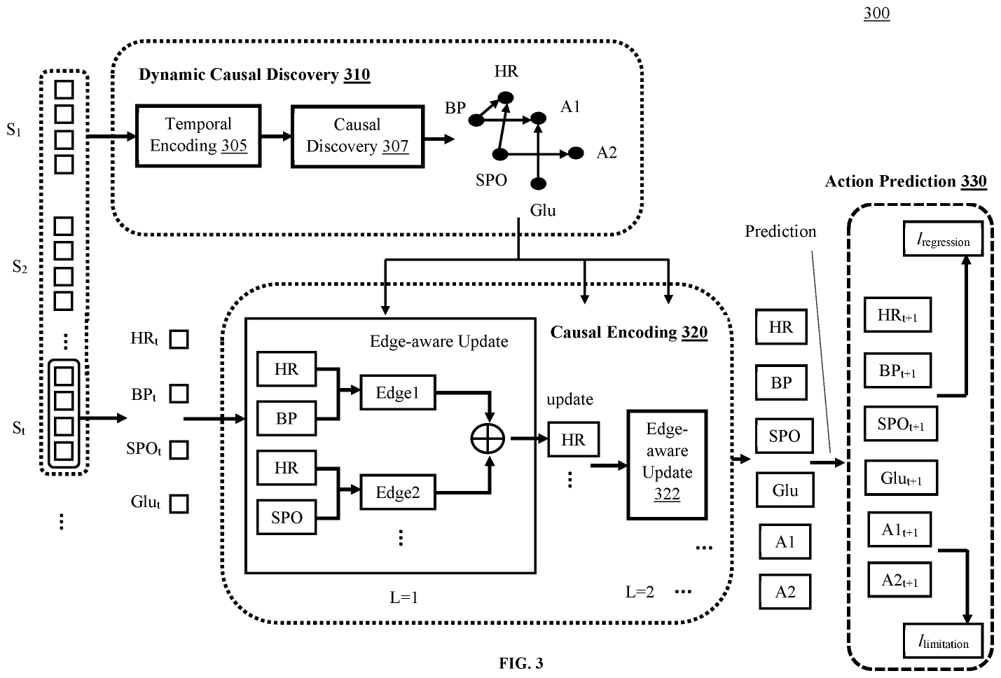

FIG. 3 is a block/flow diagram of an exemplary framework of the self-explainable imitation learning framework, in accordance with embodiments of the present invention.

The inputs of the method are demonstrations of a target task. The output is the learned policy for the agent model which could provide demonstrations similar to the experts, along with the causal relations behind its action decisions. The framework 300 includes three components, that is, the dynamic causal discovery component 310, the causal encoding component 320, and the action prediction component 330. During each inference time, in the first step, the dynamic causal discovery component 310 is used to generate the causal graph for current states by employing temporal encoding 305 and causal discovery 307. In the second step, the proposed causal encoding component 320 is used to update state variable embeddings (322) by propagating messages along those discovered causal edges. In the third step, the action prediction component 330 is adopted to conduct an imitation learning task and a state regression task by using updated state variable embeddings as evidence. During training, these three modules or components are updated in an end-to-end manner to improve the quality of discovered causal relations and for conducting imitation learning tasks simultaneously.

The input demonstration of FIG. 3 includes a sequence of observed states s and corresponding actions a, as well as usage of Treatment 1 and Treatment 2. The exemplary methods aim to learn the trained framework model, which outputs both the action predicted and the causal graph discovered for each state.

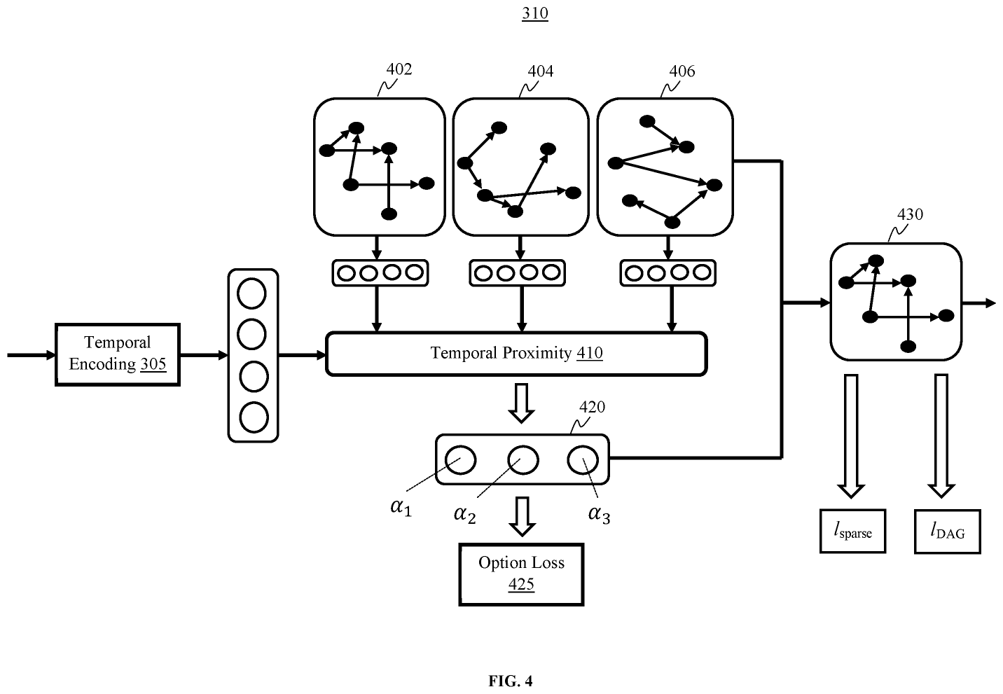

FIG. 4 is a block/flow diagram illustrating an overview of the dynamic causal discovery component 310, in accordance with embodiments of the present invention.

The design of the dynamic causal discovery component is presented in FIG. 4. Three causal graph templates, 402, 404, 406 are shown. Component 310 takes state trajectory π=(s₁, s₂, . . . , sₜ) as inputs, and first encodes it via a temporal encoding layer 305 to obtain representation zₜ. Then, its proximity 410 with templates is computed via the attention mechanism 420 on embeddings u of those templates and the causal graph 430 is generated as a weighted sum of those templates (see equations 5 and 6 below). An option loss 425 is also determined.

The quality of identified causal edges is updated based on both gradients from the other two modules/components, and three regularizations. An L1 norm is applied as the sparsity regularization to encourage the discovered causal graph being sparse, so that non-causal paths could be removed. A soft constraint on acyclicity of obtained graphs is enforced to prevent the existence of loops, as loops do not make sense in a causal graph. An option selection regularization is also adopted, which encourages states that are similar to each other to have a similar selection of those templates. For this regularization, the group of each state observation is obtained before-hand via a clustering algorithm, and then the template selection process is supervised by requiring those from the same group to select the same template. As a result, improvement of the knowledge sharing across similar instances is achieved.

To enforce consistency between identified causal edges and the behavior of the agent model, the causal encoding module/component is designed to update representations of state variables based on the discovered causal graph. The embeddings of each state variable are updated with propagated messages from variables it depends upon. An edge-aware update layer is adopted to conduct this task, and the detailed inference steps are shown in Equations 8 and 9 below. It first initializes the embedding of each variable sᵢ at time t. Then, at layer 1, it obtains the edgewise message with parameter matrix W_{edge}^{l}, before fusing them to update variable representations with parameter matrix W_{agg}^{l}. In this exemplary implementation, two such layers are stacked.

The action prediction module/component makes predictions on top of the updated variable embeddings and conducts both the imitation learning task and the regression task. The regression task is used to provide auxiliary signals for the learning of causal edges among state variables, which would be difficult to learn with signals only from the action prediction task. It is implemented as a set of three-layer MLPs, with each MLP conducting one prediction task. The supervision comes from two parts, that is, an imitation learning loss and a regression loss. The imitation loss includes an adversarial loss and a behavior cloning loss. Using r to represent expert demonstrations, π_{θ} as parameters for action prediction, and π_{ϕ}, as parameters for the state regression, all three loss terms are formed and summarized in equations 10, 11, and 12 below.

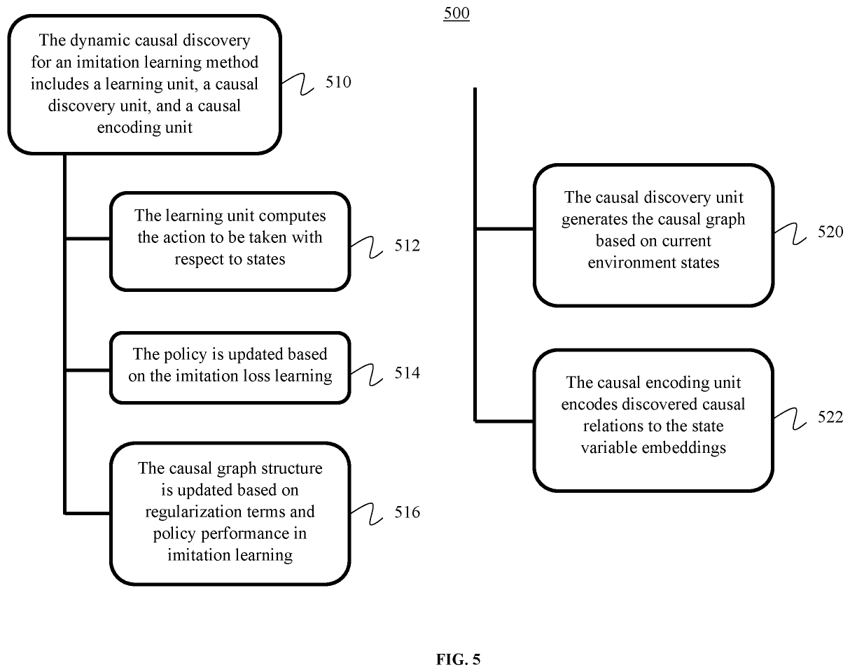

FIG. 5 is a block/flow diagram 500 of an exemplary graph illustrating the dynamic causal discovery for imitation learning, in accordance with embodiments of the present invention.

The dynamic causal discovery for an imitation learning method (510) includes a learning unit/component, a causal discovery unit/component, and a causal encoding unit/component. The learning component computes the action to be taken with respect to states (512). The policy is updated based on the imitation loss learning (514). The causal graph structure is updated based on regularization terms and policy performance in imitation learning (516). The causal discovery component generates the causal graph based on current environment states (520) and the causal encoding component encodes discovered causal relations to the state variable embeddings (522).

[symbol] and [symbol] are used to denote sets of states and actions, respectively. In a classical discrete-time stochastic control process, the state at each time step is dependent upon the state and action from the previous step: sₜ₊₁˜P(s|sₜ, aₜ). sₜ ∈ [symbol] is the state vector in time step t, including descriptions over observable state variables. aₜ ∈ [symbol] indicates actions taken in time t, and K is the size of a candidate action set | [symbol] |. Traditionally, deep reinforcement learning dedicates to learn a policy model π_{θ} to select actions given states π_{θ}(s)=Pπ_{θ}(als), which can maximize long-term rewards. In an imitation learning setting, ground-truth rewards on actions at each time step are not available. Instead, a set of demonstration trajectories r={τ₁, τ₂, . . . , τₘ} sampled from expert policy π_{E} is provided, where τᵢ=(s₀, a₀, s₁, a₁, . . . ) is the i-th trajectory with sₜ and aₜ being the state and action at time step t. Accordingly, the target is changed to learn a policy π_{θ} that mimics the behavior of expert π_{E}.

Besides obtaining the policy model π_{θ}, the exemplary methods further seek to provide interpretations for its decisions. Using notations from the causality scope, the focus is on discovering the cause-effect dependency among observed states and predicted actions encoded in π_{θ}. Without loss of generality, the exemplary methods can formalize it as a causal discovery task. The causal relations are modeled with an augmented linear Structural Equation Model (SEM):

sₜ₊₁,aₜ=f₂( [symbol] ₜ·f₁(sₜ,aₜ₋₁)) (1)

In this equation, f₁, f₂ are nonlinear transformation functions. Directed Acyclic Graph (DAG) [symbol] ₜ ∈ [symbol] ^{(S+A)×(S+A)} can be represented as an adjacency matrix as it is unattributed. [symbol] ₜ measures the causal relation of state variables s and action variable a in time step t, and sheds lights on interpreting the decision mechanism of π_{θ}. It exposes the latent interaction mechanism between state and action variables lying behind π_{θ}. The task can be formally defined as follows: Given m expert trajectories represented as τ, learn a policy model no that predicts the action aₜ based on states sₜ, along with a DAG [symbol] ₜ exposing the causal structure captured by it in the current time step. This self-explaining strategy helps to improve user understanding of the trained imitator.

The main idea of CAIL is to discover the causal relationships among state and action, and utilize the causal relations to help the agent make decisions. The discovered causal graphs can also provide a high-level interpretation on the neural agent, exposing the reasons behind its decisions. An overview of the proposed CAIL is provided in FIG. 3. A self-explaining framework is developed that can provide the latent causal graph besides predicted actions, which is composed of a causal discovery module/component 310 that constructs a causal graph capturing the casual relations among states and actions for each time step, can help decisions of which action to take next and explain the decision, a causal encoding module/component 320, which models causal graphs to encode the discovered causal relations for imitation learning, and a prediction module/component that conducts the imitation learning task based on both the current state and causal relation. All three components are trained end-to-end, and this exemplary design guarantees the conformity between discovered causal structures and the behavior of π_{θ}.

Regarding dynamic causal discovery, discovering the causal relations between state and action variables can help decision-making of neural agents and increase their interpretability. However, for many real-world applications, the latent generation process of observable states s and the corresponding action a may undergo transitions at different periods of the trajectory. For example, there are multiple stages for a patient, such as “just infected,” “become severe,” and “begin to recovery.” Different stages of patients would influence the efficacy of drug therapies, making it sub-optimal to use one fixed causal graph to model policy π_{θ}. On the other hand, separately fitting a [symbol] ₜ at each time step is an onerous task and can suffer from lack of training data.

To address this problem, a causal discovery module/component 310 is designed to produce dynamic causal graphs. It is assumed that the evolving of a time series can be split into multiple stages, and the casual relationship within each stage is static. This assumption widely holds in many real-world applications. Under this assumption, a discovery model with M DAG templates is designed, and [symbol] ₜ is extracted as a soft selection of those templates.

Regarding causal graph learning, an illustration of this causal discovery module/component is shown in FIG. 4. Specifically, an explicit dictionary { [symbol] ⁱ, i ∈[1, 2, . . . , M]} is constructed as the DAG templates. [symbol] ⁱ ∈ [symbol] ^{(s+A)×(s+A)} and these templates are randomly initialized and will be learned together with the other modules of CAIL. They encode the time-variate part of causal relations.

The exemplary methods add the sparsity constraint and the acyclicity regularizer on [symbol] ⁱ to make sure that [symbol] ⁱ is a directed acyclic graph. The sparsity regularizer applies the L1 norm on the causal graph templates to encourage sparsity of discovered causal relations so that those non-causal edges could be removed. It can be mathematically written as:

$${min}_{\{ {𝒢}^{i} , i ∈ [ 1 , 2 , … , M ] \}} {ℛ}_{sparsity} = {\sum }_{i = 1}^{M} \vert {𝒢}^{i} \vert \qquad ( 2 )$$

where | [symbol] ⁱ| denotes number of edges inside it.

In causal graphs, edges are directed and a node cannot be its own descendant. To enforce such constraint on extracted graphs, the acyclicity regularization is adopted. Concretely, [symbol] ⁱ is acyclic if and only if [symbol] ( [symbol] ⁱ)=tr[ [symbol] ]−(| [symbol] |+| [symbol] |)=0, where I is the identity matrix, ° is elementwise square, e^{A} is the matrix exponential of A, and tr denotes matrix trace. | [symbol] | and | [symbol] | are the number of state and action variables, respectively.

Then the regularizer to make the graph acyclic can be written as:

$${min}_{\{ {𝒢}^{i} , i ∈ [ 1 , 2 , … , M ] \}} {ℛ}_{DAG} = {\sum }_{i = 1}^{M} ( ℋ ( {𝒢}^{i} ) - ( \vert 𝒮 \vert + \vert 𝒜 \vert ) ) \qquad ( 3 )$$

When [symbol] _{DAG} is minimized to be 0, there would be no loops in the discovered causal graphs and they are guaranteed to be DAGs.

Regarding causal graph selection, with the DAG templates, at each time stamp t, one DAG can be selected from the templates that can describe the causal relation between state variables and actions at the current state. To achieve this, a temporal encoding network is used to learn the representation of the trajectory for input time step t as:

zₜ=Enc(s₁,s₂, . . . ,sₜ) (4)

In experiments, a Temporal CNN is applied as the encoding model. Note that other sequence encoding models like Long Short-Term Memory (LSTM) and Transformer can also be used. For each template gi, its representation is learned as:

uⁱ=g( [symbol] ⁱ) (5)

As [symbol] is unattributed and its nodes are ordered, the exemplary methods implement go as an a Multilayer Perceptron (MLP) with flattened g as input, that is, the connectivity of each node. It is noted that graph neural networks (GNNs) can also be used.

Since zₜ captures the trajectory up to time t, the exemplary methods can use zₜ to generate [symbol] ₜ by selecting from templates { [symbol] ⁱ} as:

$${α}_{t}^{i} = \frac{exp ( 〈 {z}_{t} , {u}^{i} 〉 / T )}{{\sum }_{i = 1}^{M} exp ( 〈 {z}_{t} , {u}^{i} 〉 / T )} , {𝒢}_{t} = {\sum }_{i = 1}^{M} {α}_{t}^{i} \cdot {𝒢}^{i} \qquad ( 6 )$$

where [symbol] , [symbol] denotes a vector inner-product. A soft selection is adopted by setting temperature T to a small value, e.g., 0.1. A small T would make aₜⁱ closer to 0 or 1.

To encourage the consistency in template selection across similar time steps, the template selection regularization loss is designed. Specifically, states and historical actions in each time are concatenated and clustered into M groups before-hand. qₜⁱ is used to denote whether time step t belongs to group i, which is obtained from the clustering results. Then, the loss function for guiding the template selection can be written as:

$${min}_{θ} {ℛ}_{option} = - {\sum }_{i = 1}^{M} {\sum }_{t} {q}_{t}^{i} log {α}_{t}^{i} \qquad ( 7 )$$

where aₜⁱ is the selection weight of time step t on template i from Eq.(6) and θ is the set of parameters of graph templates, temporal encoding network Enc and g( ).

Regarding causal encoding, for the purpose of learning [symbol] to capture causal structures, its consistency with the behavior of π_{θ} needs to be guaranteed. The exemplary embodiments achieve that on the input level. Specifically, variable embeddings are obtained through modeling the interactions among them based on discovered causal relations, and then π_{θ} is trained on top of these updated embeddings. In this way, the structure of [symbol] ₜ can be updated along with the optimization of π_{θ}.

Regarding variable initialization, let s_{t,j} denote state variable sⱼ at time t. First, each observed variable s_{t,j} is mapped to embeddings of the same shape for future computations with:

ĥ_{t,j}⁰=s_{t,j}·Eⱼ (8)

where Eⱼ ∈ [symbol] ^{|sj|×d} is the embedding matrix to be learned for the j-th observed variable. ĥₜ⁰ ∈ [symbol] ^{|S|×d}, d is the dimension of embedding for each variable. Itis further extended to hₜ⁰ ∈ [symbol] [symbol] + [symbol] ^{xd} to include representation of actions. Representation of these actions are initialized as zero and are learned during training.

Regarding causal relation encoding, the representation of all variables is updated using Gt, which aims to encode the casual relation with the representations. In many real-world cases, variables may include very different semantics and directly fusing them using homophily-based GNNs like GCN is improper.

To better model the heterogeneous property of variables, an edge-aware architecture is adopted as follows:

$${m}_{j \to i} = [ {h}_{i , t}^{l - 1} , {h}_{j , t}^{l - 1} ] \cdot {W}_{edge}^{l} \\ {h}_{i , t}^{l} = σ ( [ {\sum }_{j ∈ v} {\overline{𝒢}}_{j , i} {m}_{j \to i} , {h}_{i , t}^{l - 1} ] {W}_{agg}^{l} ) \qquad ( 9 )$$

where W_{edge}^{l} and W_{agg}^{l} are the parameter matrices for edgewise propagation and node-wise aggregation, respectively in layer l. m_{j→i} refers to the message from node j to node i.

Regarding the prediction module/component, after obtaining causality-encoded variable embeddings, a prediction module/component is implemented on top of them to conduct the imitation learning task. Its gradients will be backpropagated through the causal encoding module/component to the causal discovery module/component, hence informative edges including causal relations can be identified.

Regarding the imitation learning task, after previous steps, now h_{t,j} encodes both observations and causal factors for variable j. Then, predictions on aₜ are made, which is a vector of length | [symbol] |, with each dimension indicating whether to take the corresponding action or not. For action candidate α′, the process is as follows: h_{t,a}, and α′ₜ₋₁ are concatenated as the input evidence. h_{t,a}, is the obtained embedding for variable α′ at time t, and α′ₜ₋₁ corresponds to the history action from last time. The branch α′ of trained policy model π_{θ} predicts the action α′ₜ based on [h_{t,α′}, α′ₜ₋₁]. In the exemplary implementation, π_{θ} is composed of | [symbol] | branches with each branch corresponding to one certain action variable.

The proposed policy model is adversarially trained with a discriminator D to imitate expert decisions. Specifically, the policy π_{θ} aims to generate realistic trajectories that can mimic π_{E} to fool the discriminator D, while the discriminator aims to differentiate if a trajectory is from π_{θ} or π_{E}. Through such min-max game, π_{θ} can imitate the expert trajectories.

The learning objective [symbol] ᵢₘᵢ on policy π_{θ} is given as follows:

$${min}_{{π}_{θ}} {𝔼}_{( s , a ) \sim {p}_{{π}_{θ}}} log ( 1 - D ( s , a ) ) - λ H ( {π}_{θ} ) - {𝔼}_{{τ}_{i} ∈ τ} {𝔼}_{( {s}_{t} , {a}_{t} ) \sim {τ}_{i}} {P}_{{π}_{θ}} ( {a}_{t} \vert {s}_{t} ) , \qquad ( 10 )$$

where ρ_{πθ} is the trajectory generated by π_{θ} and τ is the set of expert deomonstrations.

$$H ( π ) {=}^{△} {𝔼π}_{θ} [ - log π ( a \vert s ) ]$$

is the entropy which encourages π_{θ} to explore and make diverse decisions. Discriminator D is trained to differentiate expert paths from those generated by Ire:

$${max}_{D} 𝔼ρ E log ( D ( s , a ) ) + 𝔼ρθlog ( 1 - D ( s , a ) ) \qquad ( 11 )$$

The framework is insensitive towards architecture choices of policy model π_{θ}. In the experiments, π_{θ} is implemented as a three-layer MLP, with the first two layers shared by all branches. Relu is selected as the activation function.

Regarding the auxiliary regression task, besides the common imitation learning task, an auto-regression task is conducted on state variables. This task can provide auxiliary signals to guide the discovery of causal relations, like the edge from Blood Pressure to Heart Rate.

Similar to the imitation learning task, for state variable s′, the exemplary methods use [h_{t,s′}, s′ₜ] as the evidence, and use model π_{ϕ} to predict s′ₜ₊₁ as [symbol] ᵣₑₛ:

$${min}_{{π}_{ϕ}} - {𝔼}_{{τ}_{i} ∈ τ} 𝔼 ( {s}_{t} , {a}_{t} ) ∼ {τ}_{i} log P {π}_{ϕ} ( {s}_{t + 1} \vert {h}_{t , s} , {s}_{t} ) \qquad ( 12 )$$

in which Pπ_{ϕ} denotes the predicted distribution of sₜ₊₁.

Regarding the final objective function of CAIL, the final objective function of CAIL is:

$${min}_{{π}_{ϕ} , {π}_{θ}} {max}_{D} {ℒ}_{imi} + {γ}_{1} \cdot {ℒ}_{res} + {λ}_{1} \cdot {ℛ}_{sparse} + {γ}_{2} \cdot {ℛ}_{option} s . t . {ℛ}_{DAG} = 0. \qquad ( 13 )$$

where λ₁, γ₁, and γ₂ are weights of different losses, and the constraint guarantees acyclicity in graph templates.

To solve this constrained problem in Equation 13, the augmented Lagrangian algorithm is used and its dual form is obtained as follows:

$${min}_{{π}_{ϕ} , {π}_{θ}} {max}_{D} {ℒ}_{imi} + {γ}_{1} \cdot {ℒ}_{res} + {λ}_{1} \cdot {ℛ}_{sparse} + {γ}_{2} \cdot {ℛ}_{option} + {λ}_{2} \cdot {ℛ}_{DAG} + \frac{c}{2} \dot{\vert} {ℛ}_{DAG} {\vert}^{2} , \qquad ( 14 )$$

where λ₂ is the Lagrangian multiplier and c is the penalty parameter.

Algorithm 1 Full Training Algorithm

| Require: Demonstrations τ generated from expert policy π_{Ε}, | |
|---|---|
| | initial template set { [symbol] ⁱ, i ∈ [1,2, ..., M]}, initial model |
| | parameter θ, ϕ, hyperparameters λ₁, λ₂, γ₁, γ₂, c, initialize |
| | [symbol] old = inf, parameter in Augmented Lagrangian: σ = ¼, |
| | ρ = 10 |
| 1: | while Not Converged do |
| 2: | for τᵢ ~ τ do |
| 3: | Update parameter of discriminator D to increase the |
| | loss of Equation 11; |
| 4: | Update θ, ϕ, with gradients to minimize Equation 13; |
| 5: | end for |
| 6: | Compute [symbol] with Equation 3; |
| 7: | λ₂ ← λ₂ + [symbol] · c |
| 8: | if [symbol] ≤ σ [symbol] old then |
| 9: | c ← c * ρ |
| 10: | end if |
| 11: | [symbol] old ← [symbol] |
| 12: | end while |
| 13: | return Learned templates { [symbol] ⁱ, i ∈ [1,2, ..., M]}, trained |
| | policy model π_{θ} |

The optimization steps are summarized in Algorithm 1, reproduced above. Within each epoch, the discriminator and the model parameters θ, ϕ are updated iteratively, as shown from line 2 to line 5. Between each epoch, the augmented Lagrangian algorithm is used to update the multiplier λ₂ and penalty weight c from line 6 to line 11. These steps progressively increase the weight of [symbol] _{DAG}, so that it will gradually converge to zero and templates will satisfy the DAG constraint.

In conclusion, to increase transparency and offer better interpretability of the neural agent, the exemplary methods propose to expose its captured knowledge in the form of a directed acyclic causal graph, with nodes being action and state variables, and edges denoting the causal relations between them. Furthermore, this causal discovery process is designed to be state-dependent, enabling it to model the dynamics in latent causal graphs. The exemplary methods conduct causal discovery from the perspective of Granger causality, and propose a self-explainable imitation learning framework, that is, GAIL. The proposed framework is composed of three parts, that is, a dynamic causal discovery module/component, a causality encoding module/component, and a prediction module/component, and is trained in an end-to-end manner. After the model is learned, causal relations can be obtained among states and action variables behind its decisions, exposing policies learned by it.

Moreover, the exemplary methods could discover the causal relations among states and action variables by being trained together with the imitation learning agent and making the agent be dependent upon discovered causal edges. The exemplary methods propose a dynamic causal relation discovery module/component with a latent causal graph template set. It can both model different causal graphs for different environment states and provide similar causal graph for similar states. The exemplary methods further propose a causal encoding module/component so that discovered causal edges can be encoded into state embeddings, and the quality of discovered causal relations can be improved using gradients from the agent model. The exemplary methods further use a set of regularization terms to further improve the quality of obtained causal graphs, like sparsity constraint and acyclicity constraint. This feature enables it to obtain more realistic causal graphs.

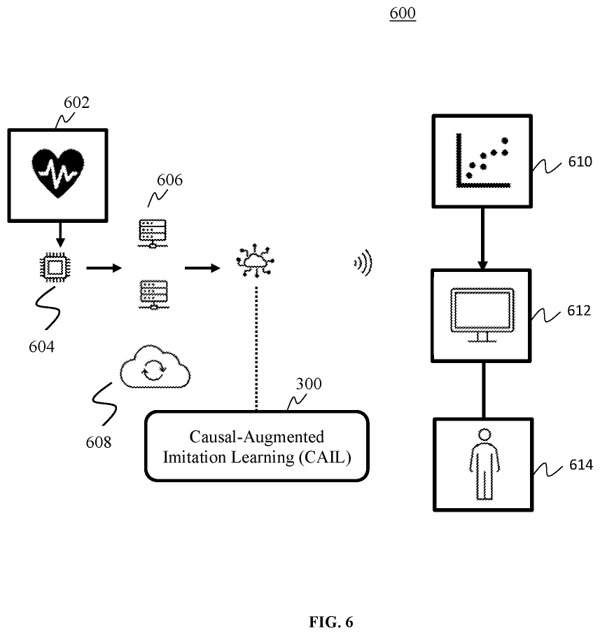

FIG. 6 is a block/flow diagram 600 of a practical application for learning a self-explainable imitator by discovering causal relationships between states and actions, in accordance with embodiments of the present invention.

In one practical example, patient health data 602 is processed by processor 604, the data 602 sent via servers 606 or a cloud 608 to the CAIL 300 for further processing. CAIL 300 sends or transmits the learned policy 610 to a display 612 to be analyzed by a user or healthcare provider or doctor or nurse 614.

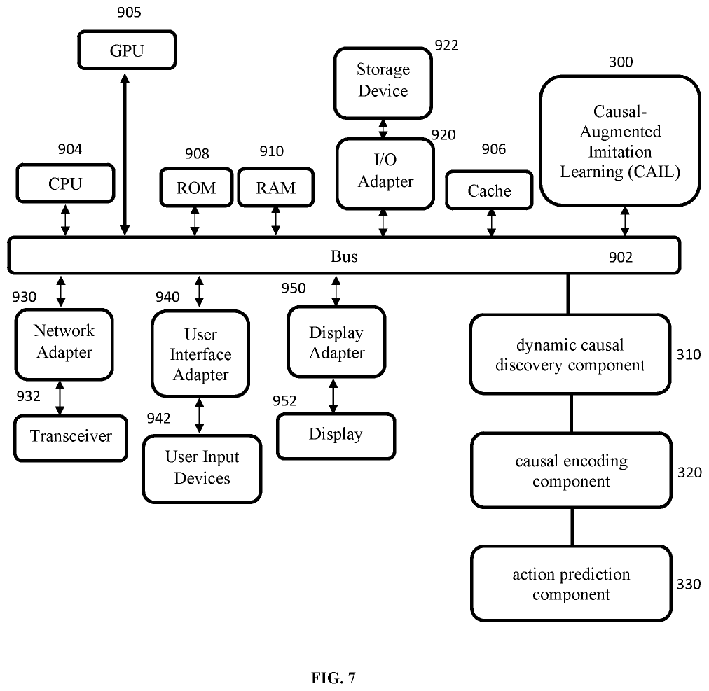

FIG. 7 is an exemplary processing system for learning a self-explainable imitator by discovering causal relationships between states and actions, in accordance with embodiments of the present invention.

The processing system includes at least one processor (CPU) 904 operatively coupled to other components via a system bus 902. A GPU 905, a cache 906, a Read Only Memory (ROM) 908, a Random Access Memory (RAM) 910, an input/output (I/O) adapter 920, a network adapter 930, a user interface adapter 940, and a display adapter 950, are operatively coupled to the system bus 902. Additionally, the Causal-Augmented Imitation Learning (GAIL) framework is implemented by employing three modules or components, that is, a dynamic causal discovery component 310, a causal encoding component 320, and an action prediction component 330.

A storage device 922 is operatively coupled to system bus 902 by the I/O adapter 920. The storage device 922 can be any of a disk storage device (e.g., a magnetic or optical disk storage device), a solid-state magnetic device, and so forth.

A transceiver 932 is operatively coupled to system bus 902 by network adapter 930.

User input devices 942 are operatively coupled to system bus 902 by user interface adapter 940. The user input devices 942 can be any of a keyboard, a mouse, a keypad, an image capture device, a motion sensing device, a microphone, a device incorporating the functionality of at least two of the preceding devices, and so forth. Of course, other types of input devices can also be used, while maintaining the spirit of the present invention. The user input devices 942 can be the same type of user input device or different types of user input devices. The user input devices 942 are used to input and output information to and from the processing system.

A display device 952 is operatively coupled to system bus 902 by display adapter 950.

Of course, the processing system may also include other elements (not shown), as readily contemplated by one of skill in the art, as well as omit certain elements. For example, various other input devices and/or output devices can be included in the system, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system are readily contemplated by one of ordinary skill in the art given the teachings of the present invention provided herein.

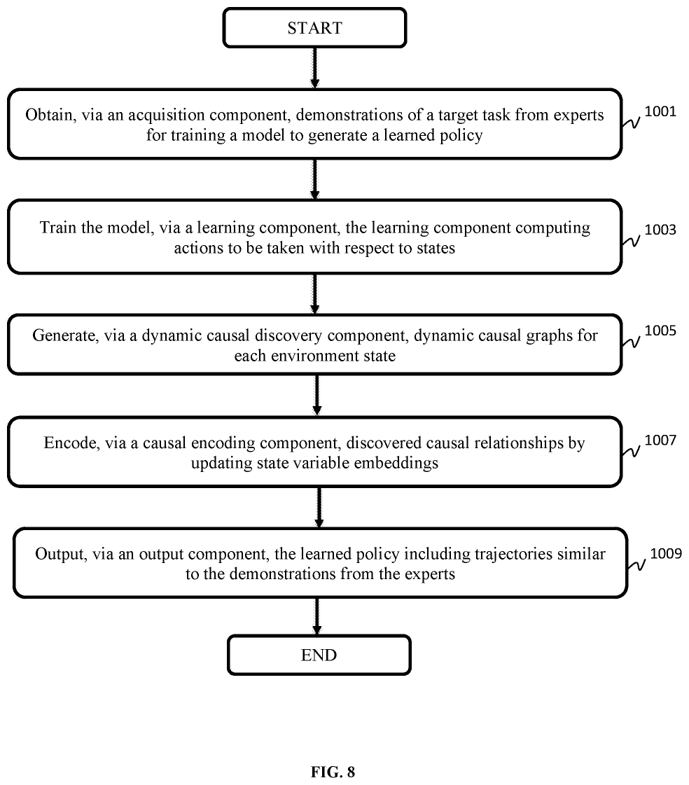

FIG. 8 is a block/flow diagram of an exemplary method for learning a self-explainable imitator by discovering causal relationships between states and actions, in accordance with embodiments of the present invention.

The compute requirements and the network requirements of the application are managed simultaneously by:

At block 1001, obtain, via an acquisition component, demonstrations of a target task from experts for training a model to generate a learned policy.

At block 1003, train the model, via a learning component, the learning component computing actions to be taken with respect to states.

At block 1005, generate, via a dynamic causal discovery component, dynamic causal graphs for each environment state.

At block 1007, encode, via a causal encoding component, discovered causal relationships by updating state variable embeddings.

At block 1009, output, via an output component, the learned policy including trajectories similar to the demonstrations from the experts.

As used herein, the terms “data,” “content,” “information” and similar terms can be used interchangeably to refer to data capable of being captured, transmitted, received, displayed and/or stored in accordance with various example embodiments. Thus, use of any such terms should not be taken to limit the spirit and scope of the disclosure. Further, where a computing device is described herein to receive data from another computing device, the data can be received directly from the another computing device or can be received indirectly via one or more intermediary computing devices, such as, for example, one or more servers, relays, routers, network access points, base stations, and/or the like. Similarly, where a computing device is described herein to send data to another computing device, the data can be sent directly to the another computing device or can be sent indirectly via one or more intermediary computing devices, such as, for example, one or more servers, relays, routers, network access points, base stations, and/or the like.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” “calculator,” “device,” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical data storage device, a magnetic data storage device, or any suitable combination of the foregoing. In the context of this document, a computer readable storage medium may be any tangible medium that can include, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electromagnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the present invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks or modules.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks or modules.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks or modules.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the principles of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A method for learning a self-explainable imitator by discovering causal relationships between states and actions, the method comprising:
obtaining, via an acquisition component, demonstrations of a target task from experts for training a model to generate a learned policy;
training the model, via a learning component, the learning component computing actions to be taken with respect to states;
generating, via a dynamic causal discovery component, dynamic causal graphs for each environment state;
encoding, via a causal encoding component, discovered causal relationships by updating state variable embeddings; and
outputting, via an output component, the learned policy including trajectories similar to the demonstrations from the experts.

2. The method of claim 1, further comprising conducting an imitation learning task and a state regression task, via an action prediction component, by employing the updated state variable embeddings as evidence.

3. The method of claim 2, wherein the state regression task is used to provide auxiliary signals for learning causal edges among state variables.

4. The method of claim 2, wherein, for the imitation learning task, the learned policy is implemented as a three-layer Multilayer Perceptron (MLP), with two layers shared between all branches, where each MLP conducts one prediction task.

5. The method of claim 1, wherein the state variable embeddings are updated with propagated messages from variables it depends on by employing an edge-aware update layer.

6. The method of claim 1, wherein the dynamic causal discovery component includes construction of an explicit dictionary as Directed Acrylic Graph (DAG) templates, the DAG templates randomly initialized.

7. The method of claim 1, wherein a sparsity constraint and an acyclicity constraint are employed to optimize the dynamic causal graphs, and a template selection regularization loss is employed to enable consistency in template selection across similar time steps.

8. A non-transitory computer-readable storage medium comprising a computer-readable program for learning a self-explainable imitator by discovering causal relationships between states and actions, wherein the computer-readable program when executed on a computer causes the computer to perform the steps of:
obtaining, via an acquisition component, demonstrations of a target task from experts for training a model to generate a learned policy;
training the model, via a learning component, the learning component computing actions to be taken with respect to states;
generating, via a dynamic causal discovery component, dynamic causal graphs for each environment state;
encoding, via a causal encoding component, discovered causal relationships by updating state variable embeddings; and
outputting, via an output component, the learned policy including trajectories similar to the demonstrations from the experts.

9. The non-transitory computer-readable storage medium of claim 8, wherein an imitation learning task and a state regression task are conducted, via an action prediction component, by employing the updated state variable embeddings as evidence.

10. The non-transitory computer-readable storage medium of claim 9, wherein the state regression task is used to provide auxiliary signals for learning causal edges among state variables.

11. The non-transitory computer-readable storage medium of claim 9, wherein, for the imitation learning task, the learned policy is implemented as a three-layer Multilayer Perceptron (MLP), with two layers shared between all branches, where each MLP conducts one prediction task.

12. The non-transitory computer-readable storage medium of claim 8, wherein the state variable embeddings are updated with propagated messages from variables it depends on by employing an edge-aware update layer.

13. The non-transitory computer-readable storage medium of claim 8, wherein the dynamic causal discovery component includes construction of an explicit dictionary as Directed Acrylic Graph (DAG) templates, the DAG templates randomly initialized.

14. The non-transitory computer-readable storage medium of claim 8, wherein a sparsity constraint and an acyclicity constraint are employed to optimize the dynamic causal graphs, and a template selection regularization loss is employed to enable consistency in template selection across similar time steps.

15. A system for learning a self-explainable imitator by discovering causal relationships between states and actions, the system comprising:
a memory; and
one or more processors in communication with the memory configured to:
obtain, via an acquisition component, demonstrations of a target task from experts for training a model to generate a learned policy;
train the model, via a learning component, the learning component computing actions to be taken with respect to states;
generate, via a dynamic causal discovery component, dynamic causal graphs for each environment state;
encode, via a causal encoding component, discovered causal relationships by updating state variable embeddings; and
output, via an output component, the learned policy including trajectories similar to the demonstrations from the experts.

16. The system of claim 15, wherein an imitation learning task and a state regression task are conducted, via an action prediction component, by employing the updated state variable embeddings as evidence.

17. The system of claim 16, wherein the state regression task is used to provide auxiliary signals for learning causal edges among state variables.

18. The system of claim 16, wherein, for the imitation learning task, the learned policy is implemented as a three-layer Multilayer Perceptron (MLP), with two layers shared between all branches, where each MLP conducts one prediction task.

19. The system of claim 15, wherein the state variable embeddings are updated with propagated messages from variables it depends on by employing an edge-aware update layer.

20. The system of claim 15, wherein the dynamic causal discovery component includes construction of an explicit dictionary as Directed Acrylic Graph (DAG) templates, the DAG templates randomly initialized.
